(19) United States
(12) Patent Application Publication
(10) Pub. No.: US 2003/0208361 A1
(43) Pub. Date: Nov. 6, 2003

(54) Configuration of systems with services

(76) Inventors: Daryl Jarvis Belinne, Austin, TX (US); Shree Dandekar, Austin, TX (US); James A. Howell JR., Georgetown, TX (US); Shannon Christopher Boesch, Austin, TX (US)

Correspondence Address: Stephen A. Terrile, Attorney for Applicant(s), HAMILTON & TERRILE, LLP, PO Box 203518, Austin, TX, 78720, US

(21) Appl. No.: 10/137,623

(22) Filed: May 2, 2002

(51) Int. Cl. G06F 17/60

(52) U.S. Cl. 705/1

(57) ABSTRACT

The invention relates to an on-line store which allows a customer to order services of other providers while maintaining a consistent customer experience and control over the customer. Additionally, the invention relates to a system for enabling configuration of an information handling system which includes a configurator, a checkout module, a service activation module, and a database. The configurator configures the system with options selected according to user input. Payment options, obtaining payment and delivery information are presented by the checkout module. The service activation module enables a user to activate a service and a database receives and supplies information to the configurator, the checkout module and the service activation module. The invention also relates to a method of enabling configuration of an information handling system which includes configuring a system with options selected according to user input, presenting payment options and obtaining payment and delivery information during the checkout process, enabling a user to activate a service; and using information derived during the configuring for the enabling. The invention further relates to an on-line store for enabling configuration of an information handling system which includes configuring a system with options selected according to user input, presenting payment options and obtaining payment and delivery information, enabling a user to activate a service; and a database. The database receives and supplies information from and to the configurator, the checkout module and the service activation module.

### BACKGROUND OF THE INVENTION

1. Field of the Invention

The present invention relates to build to order systems, and more particularly, services activation during ordering a build to order system

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A first generation web based on-line store provided a customer with an ability to select a base information handling system, customize the system and price it. Such an on-line store focused initially upon the bare necessities. That is, build a system and get a price. A configurator allowed the customer to customize and procure the system on-line. The configurator allowed the customer to select a given system model and to customize the system according to the user selected options. Such a configurator was most well received by knowledgeable customers, that is, those who were very self-sufficient without the assistance of a sales representative.

Known on-line stores included a web objects based application providing the capability to custom configure and order a particular system. The initial on-line store application offered customers the ability to select and price key system options, the ability to include multiple systems on a single order, and the ability to provide information necessary for the placement of a standard system order.

The capability to self-select system options and then price the options was provided via an on-line configurator. This configurator enabled customer selection of key, system-defining components from a display of available system options for a chosen system. The display of available options included the presentation of a “delta” price, wherein a change in system price was affected by selection of an option. The configurator provided the ability to update overall system priced based upon selections made. The capability to include multiple items in a single order was afforded by the presence of a “shopping cart,” wherein the shopping cart represents an equivalent to the traditional shopping cart. The shopping cart enabled customers to group disparate systems together as an order, as well as specify a quantity for each individual system to be included on the order. Furthermore, the capability to provide customer-specific information required for the placement of a standard order was provided via an on-line “checkout,” the checkout including essentially a form for facilitating the capture of requested and required information. The checkout form included simple logic rules to assure entry of the required fields.

After a system is order, the customer may be provided to opportunity to order a particular service such as Internet service. When the customer indicates a desire to order such a service, then the on-line store transfers (i.e., links) the customer to the web site for the particular service in which the customer is interested. Often the web site for the service provides its own look and feel, different from the look and feel of the on-line store. Also, the customer experience changes with the link to the web site of the service provided. Also, after the customer has transferred to the new web site, the original on-line store no longer has control or can access the information provided by the customer.

### SUMMARY OF THE INVENTION

In accordance with the present invention, an on-line store is provided which allows a customer to order services of other providers while maintaining a consistent customer experience and control over the customer.

In one embodiment, the invention relates to a system for enabling configuration of an information handling system which includes a configurator, a checkout module, a service activation module, and a database. The configurator configures the system with options selected according to user input. Payment options, obtaining payment and delivery information are presented by the checkout module. The service activation module enables a user to activate a service and a database receives and supplies information to the configurator, the checkout module and the service activation module.

In another embodiment, the invention relates to a method of enabling configuration of an information handling system which includes configuring a system with options selected according to user input, presenting payment options and obtaining payment and delivery information during the checkout process, enabling a user to activate a service; and using information derived during the configuring for the enabling.

In an another embodiment, the invention relates to an on-line store for enabling configuration of an information handling system which includes configuring a system with options selected according to user input, presenting payment options and obtaining payment and delivery information, enabling a user to activate a service; and a database. The database receives and supplies information from and to the configurator, the checkout module and the service activation module.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows access to the on-line store via the Internet using a computer system.

FIG. 3 shows a system block diagram of an information handling system.

FIG. 4 shows a system block diagram representation of another on-line store.

FIG. 5 shows a system block diagram representation of another on-line store.

### DETAILED DESCRIPTION

An on-line store is one component of an Internet website to which a customer may go to configure a particular information handling system, for example, according to desired options of the customer. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

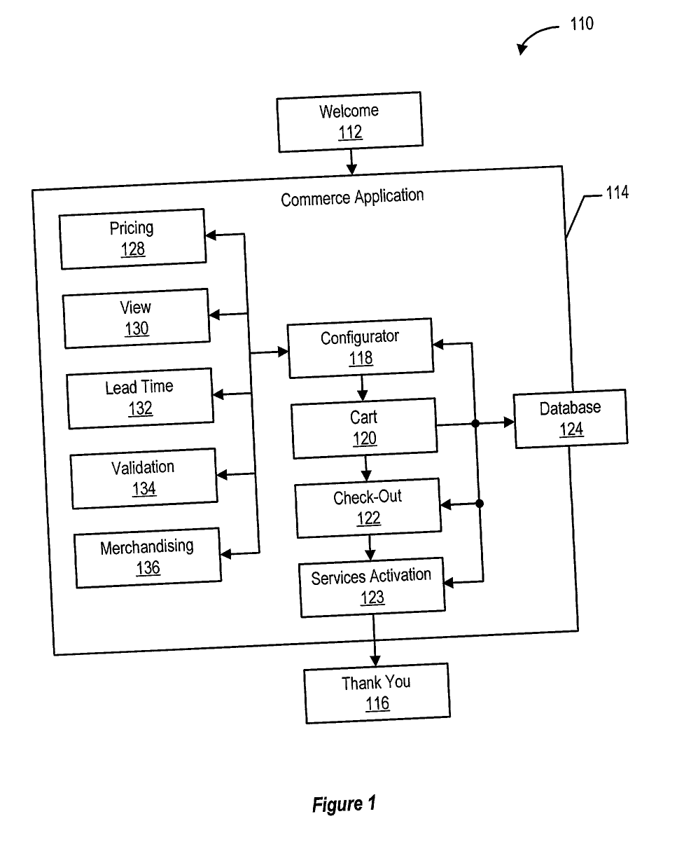

Referring now to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122 and services activation module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and services activation module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the services activation module 123 presents a services activation page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, a customer is transferred to a services activation page in which the customer is provided an opportunity to activate various services such as internet service or content services such as music services. After completion of the services activation module 123, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and services activation module 123 are each part of the commerce application 114 and interact with the database 124. For example, with the shopping cart 120, additional merchandising information associated with a particular system which has been configured and placed in the shopping cart by an on-line store customer can be provided.

Also for example, various services may be provided for order by the customer by the services activation module 123 based upon the type of system ordered as well as components that are included within the system ordered. Additionally, by providing the services activation module within the commerce application 114, the customer continues the experience a similar customer experience and the system provider is able to use the information from the database 124 and to maintain control over the customer contact. By maintaining control over the customer contact the system provider is able to determine what services are activated and to maintain accurate and up to date records of the service activation.

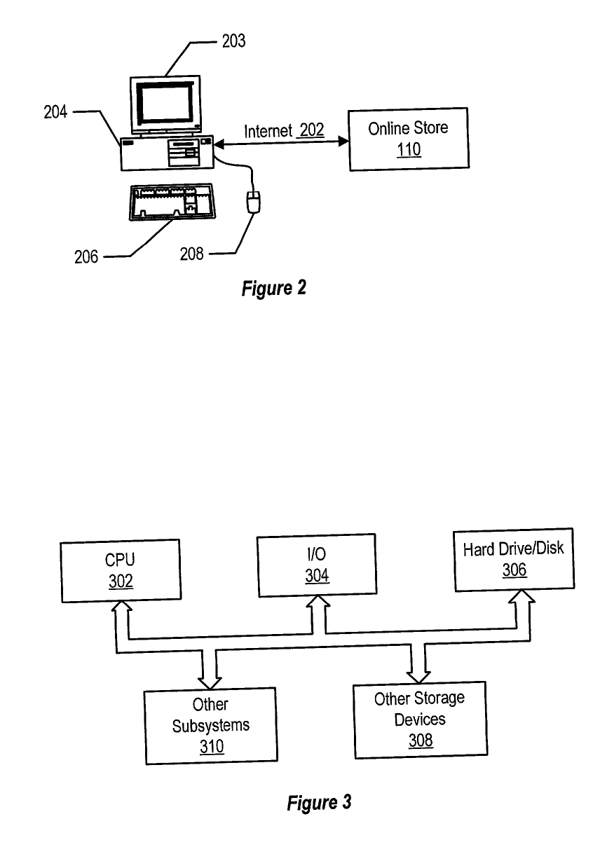

Referring to FIG. 2, a customer can access the on-line store 110 using any suitable computer equipment 200, via the Internet 202. The computer equipment 140 may include a display 203, computer 204, keyboard 206, and pointing device 208. Display 203 is used for displaying the various pages of the on-line store while a customer is using the on-line store.

Referring briefly to FIG. 3, a system block diagram of an information handling system 150 is shown having features thereof configured in accordance with the on-line store 110 as discussed herein. The information handling system 150 includes a processor 302, input/output (I/O) devices, such as a display, a keyboard, a mouse, and associated controllers, collectively designed by a reference numeral 304, a hard disk and drive 306, and other storage devices, such as a floppy disk and drive and other memory devices, collectively designated by a reference numeral 308, and various other subsystems, collectively designated by a reference numeral 310, all interconnected via one or more buses, shown collectively as a bus 312.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Other Embodiments

Other embodiments are within the following claims.

For example, the services activation module 123 which interacts with the database 124 may be used by a telephone sales person when a system is being ordered via the telephone. In this situation, the information that is derived by the telephone sale person during a customer interview is then used to provide the customer with the option of services activation. Accordingly, the customer continues the experience a similar customer experience and the system provider is able to use the information from its database and to maintain control over the customer contact. By maintaining control over the customer contact the system provider is able to determine what services are activated and to maintain accurate and up to date records of the service activation.

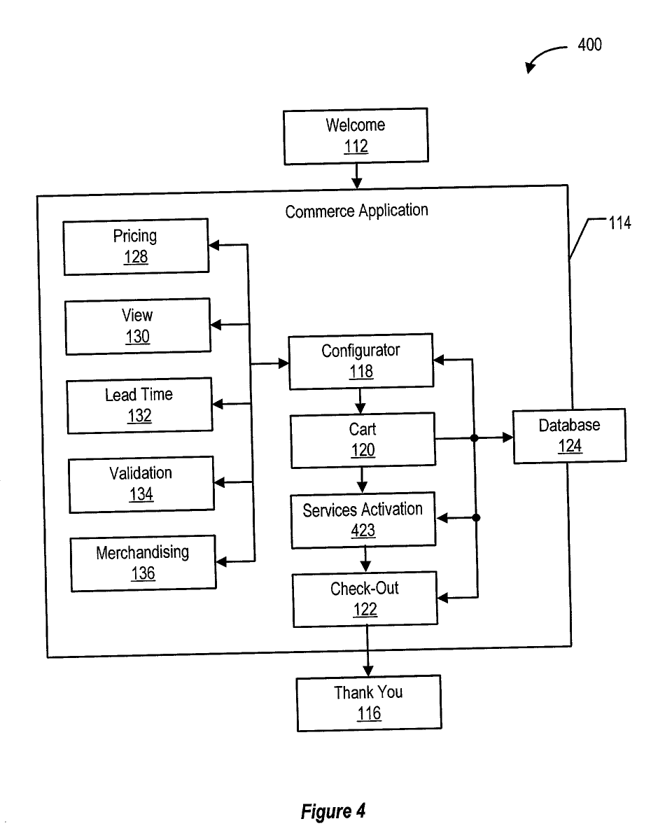

Also for example, FIG. 4 shows a system block diagram of another on-line store 400. In the on-line store shown in FIG. 4, the commerce application 114 includes a configurator 118, shopping cart 120, a checkout module 122, a services activation module 423 and database 124. The database 124 provides information to the configurator 118, shopping cart 120, checkout module 122 and services activation module 123. The various modules of the configurator 118 are driven by data from the database 124, and thus the configurator 118, shopping cart 120, checkout module 122 and services activation module 423 are all linked to the database 124.

In operation of the on-line store 400, upon completion of configuration of a system, the customer is provided with a services activation page in which the customer is provided an opportunity to activate various services via the services activation module 423. After the services activation is completed, the customer is transferred to a checkout page. After the check out is completed, the customer is transferred to a static thank you page 116. The thank you page provides a message of gratitude to the customer for having placed the order or for visiting the on-line store.

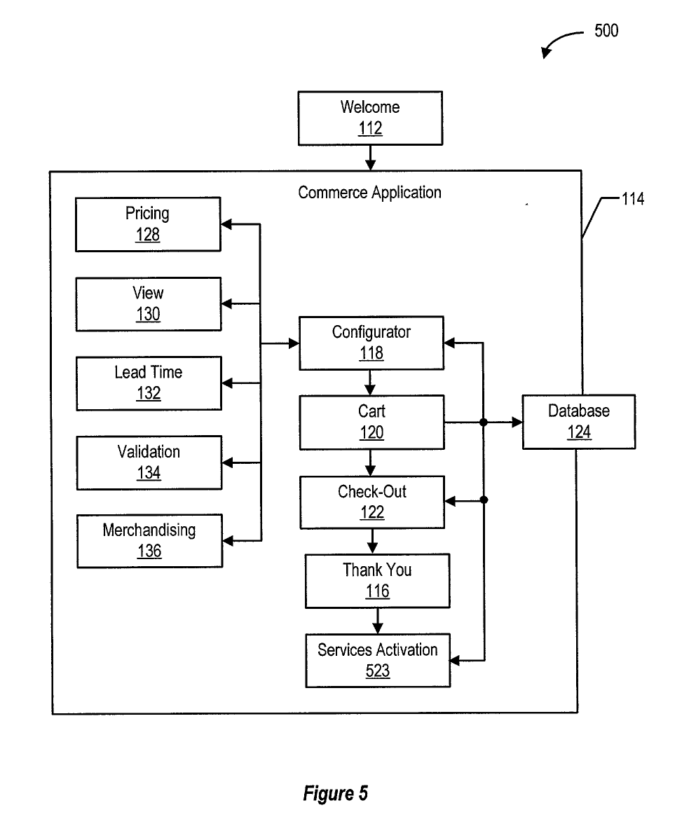

Also for example, FIG. 5 shows an example of another on-line store. In the on-line store shown in FIG. 5, the commerce application 114 includes a configurator 118, shopping cart 120, a checkout module 122, a thank you module 510, a services activation module 523 and database 124. The database 124 provides information to the configurator 118, shopping cart 120, checkout module 122 and services activation module 523. The various modules of the configurator 118 are driven by data from the database 124, and thus the configurator 118, shopping cart 120, checkout module 122 and services activation module 523 are all linked to the database 124.

In operation of the on-line store 500, upon completion of configuration of a system, the customer is transferred to a checkout page. After completing checkout of the purchase of the information handling system and after the thank you page is presented, the customer is provided with a services activation page in which the customer is provided an opportunity to activate various services via the services activation module 523. The services activation module 523 also provides the means to complete the commercial portion of the services activation.

Also for example, while specific services are identified as being activated by the services activation module, other services may also be activated by the services activation module.

What is claimed is:

1. A system for enabling configuration of an information handling system comprising:
a configurator, the configurator configuring a system with options selected according to user input;
a checkout module, the checkout module presenting payment options and obtaining payment and delivery information;
a service activation module for enabling a user to activate a service; and
a database, the database receiving information from and supplying information to the configurator, the checkout module and the service activation module.

2. The system of claim 1 wherein:
the configurator and the service activation module provide a customer with a consistent customer experience.

3. The system of claim 1 wherein
the service activation module enables a user to activate services based upon the options selected according to user input.

4. The system of claim 1 wherein the services activation module is coupled between the configurator and the checkout module.

5. The system of claim 1 wherein the services activation module enables activation of a service after checkout has occurred.

6. The system of claim 1 wherein the service activation module generates information relating to the services activated by the user.

7. A method of enabling configuration of an information handling system comprising:
configuring a system with options selected according to user input;
presenting payment options and obtaining payment and delivery information during a checkout process;
enabling a user to activate a service; and
using information derived during the configuring for the enabling.

8. The method of claim 7 further comprising
providing a customer with a consistent customer experience during the configuring and the enabling.

9. The system of claim 7 wherein
the enabling allows a user to activate services based upon the options selected according to user input.

10. The system of claim 7 wherein
the enabling occurs after the configuring and before the presenting of payment options.

11. The system of claim 7 wherein
the enabling occurs after the presenting of payment options.

12. The system of claim 7 further comprising
generating information relating to the services activated by the user.

13. An on-line store for enabling configuration of an information handling system comprising:
means for configuring a system with options selected according to user input;
means for presenting payment options and obtaining payment and delivery information;
means for enabling a user to activate a service; and
a database, the database receiving information from and supplying information to the configurator, the checkout module and the service activation module.

14. The on-line store of claim 13 wherein:
the means for configuring and the means for enabling provide a customer with a consistent customer experience.

15. The on-line store of claim 13 wherein
the means for enabling enables a user to activate services based upon the options selected according to user input.

16. The on-line store of claim 13 further comprising
means for generating information relating to the services activated by the user.
